(19) United States
(12) Patent Application Publication
(10) Pub. No.: US 2005/0281249 A1
(43) Pub. Date: Dec. 22, 2005

(54) Multi-instancing of routing/forwarding tables and socket API

(75) Inventors: Vijay K. Chander, Livermore, CA (US); Ramkumar Sankar, Santa Clara, CA (US); Sreeram P. Iyer, Sunnyvale, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/154,615

(22) Filed: Jun. 17, 2005

Related U.S. Application Data
(60) Provisional application No. 60/580,394, filed on Jun. 18, 2004.

(51) Int. Cl. H04L 12/28

(52) U.S. Cl. 370/351; 370/400; 370/432

(57) ABSTRACT

There is disclosed a distributed platform that includes a plurality of nodes for controlling a data flow. According to this distribution platform, at least one of the plurality of nodes supports multiple instances. Also according to this platform, there is provided means for distributing classification rules for any given instance between nodes sharing the instance.

### BACKGROUND OF THE INVENTION

1. Field of the Invention

The present invention relates to communications in networks. More particularly, the invention relates to a distributed routing platform.

2. Description of the Related Art

In packet-based networks, packets are routed by being passed between network devices, known as routers. In this way packets are routed from a source to a destination. As each packet moves through the network, each router may perform packet forwarding decisions for that packet independent of other routers and other packets.

A routing table and flow module (RTFM) is an infrastructure module that allows routing protocols and other applications to insert rules into a database contained therein. The RTFM determines the best rule based on the rule parameters. It provides efficient means of storage of the rules, and mechanisms for applications to search the tables (containing the rules) based on certain keys.

In a distributed routing platform, the rules are distributed to all nodes in the distributed system through a rule distributor (RD) module. Each node is associated with its own rule distributor. One of the rule distributors may be designated as the master RD, which manages the best rules of the whole system and distributes them to all slave RDs. Each node also has an RTFM. The RTFM maintains the rule database, redistribution template database, and other data structures and interfaces to facilitate routing.

The Berkeley domain socket (BSD) interface is a popular network programming interface for users to implement TCP/UDP (transport control protocol/user datagram protocol) based applications. The standard BSD socket interface does not provide a method for applications to perform operations for a specific IP instance. There is no known multi-instance version of sockets implemented as part of a single process.

For an understanding of the state of the art, reference is made to U.S. Patent Application Publication No. 20030051048 and U.S. Pat. No. 6,594,704. U.S. Patent Application Publication No. 20030051048 discloses multi-instancing on centralised platforms having multiple processes of each module implementing an instance or routing domain, which has the disadvantage of not being scalable, since the resources required from the operating system are quite high. U.S. Pat. No. 6,594,704 describes maintaining a single table of rules belonging to different VPNs by qualifying through a VPN-id. This solution is specific to VPN and does not address other types of rules. The disclosed technique also uses a single-table approach, which is not easily scalable.

It is an aim of the present invention to provide improved techniques.

### SUMMARY OF THE INVENTION

According to the invention there is provided a distributed platform including a plurality of nodes for controlling a data flow, in which at least one of said plurality of nodes supports multiple instances, wherein there is provided means for distributing classification rules for any given instance between nodes sharing said instance.

The distributed platform may comprise a distributed routing platform, said plurality of nodes comprising a plurality of routing modules. At least one of said plurality of routing modules may support multiple instances, wherein there is provided means for sharing classification rules for any given instance between routing modules supporting said instance.

An instance may correspond to a domain or a flow direction. The flow direction may be an ingress direction or an egress direction.

A plurality of the routing modules may support multiple instances, one of said plurality of routing modules being designated as a master routing module for any given instance, and controlling the share of classification rules for that instance.

The routing module may include a routing table and flow module for the storing classification rules of the module, and a route distributor for distributing classification rules.

The routing table and flow module may store classification rules only for those instances associated with its routing module.

The route distributor may be adapted to distribute classification rules for any given instance to rule distributors of other routing modules associated with the instance with which the rule is associated. An instance may be created responsive to an event or trigger. An instance may be created responsive to configuration of an instance at a routing module.

An instance may be created responsive to creation of a physical interface or logical interface at a routing module. An instance may be created responsive to registration of an application protocol. An instance may be created responsive to receipt of a packet associated with an instance.

The distributed platform may comprise a distributed socket platform, said plurality of nodes comprising a plurality of sockets. Each socket may be adapted at the API layer to support multi-instancing. Said plurality of sockets may comprise Berkeley domain sockets, BSDs. In an aspect a Berkeley domain socket may include an application interface layer adapted to support multi-instancing.

In a further aspect there is provided a method for a distributed platform including a plurality of nodes for controlling a data flow, comprising adapting at least one of said plurality of nodes to support multiple instances, and distributing classification rules for any given instance between nodes sharing said instance.

The distributed platform may comprise a distributed routing platform, said plurality of nodes comprising a plurality of routing modules.

At least one of said plurality of routing modules may support multiple instances, the method comprising the step of sharing classification rules for any given instance between routing modules supporting said instance. An instance may correspond to a domain or a flow direction. The flow direction may be an ingress direction or an egress direction.

A plurality of the routing modules may support multiple instances, the method comprising the step of designating one of said plurality of routing modules as a master routing module for any given instance; and controlling the share of classification rules for that instance.

A routing module may include a routing table and flow module for performing the step of storing classification rules of the module, and a route distributor for performing the step of distributing classification rules.

The method may further comprise the step of storing the classification rules in the routing table and flow module stores only for those instances associated with its routing module.

The route distributor may perform the step of distributing classification rules for any given instance to rule distributors of other routing modules associated with the instance with which the rule is associated.

The method may further comprise the step of creating an instance responsive to an event or trigger. The step of creating an instance may be responsive to configuration of an instance at a routing module. The step of creating an instance may be responsive to creation of a physical interface or logical interface at a routing module. The step of creating an instance may be responsive to registration of an application protocol. The step of creating an instance may be responsive to receipt of a packet associated with an instance.

The method may comprise a distributed socket platform, said plurality of nodes comprising a plurality of sockets. The method may comprise the step of adapting each socket at the API layer to support multi-instancing. Said plurality of sockets may comprise Berkeley domain sockets, BSDs.

In a further aspect a distributed routing platform may include a plurality of routing modules for controlling a data flow, in which a plurality of said nodes support multiple instances, wherein each routing module includes a routing table and flow module for storing classification rules associated with the instances supported by a respective routing module, and a route distributor for distributing there is classification rules for any given instance between routing modules sharing said instance.

The route distributor of each routing module may be adapted to communicate with route distributor of each other routing module, such that the routing table and flow module of each routing module receives only classification rules associated with its supported instances.

In a first specific embodiment, the invention relates to networks, and more particularly to providing an update to a routing table in a distributed routing platform. The invention relates to a generic instancing mechanism for a routing table and flow module. Generic instancing of the rule distributor in a distributed routing platform is also addressed. The applications that may make use of this mechanism include, but are not limited to, virtual router implementations and virtual private network implementations.

Embodiments of the invention describe a generic mechanism to manage different types of routes/flows (rules) which may belong to different routing domains, in a router environment.

For example, this may relate to rules belonging to different virtual routers, virtual private networks, unidirectional look up rules (such as routes that are used only in the egress direction), and access control lists. The invention thus provides, in embodiments, a generic multi-instancing mechanism that addresses all of these in a uniform way.

Another example of usage of a routing table and flow module, RTFM, instance is to store the <SA, DA, sport, dport> socket lookup table as part of an RTFM instance, and to perform the socket connection lookup using this table. Moreover, on systems with hardware packet lookup capability, this table may be used to program the hardware lookup table, on this node as well as other nodes in the distributed system.

The routing table and flow module and the rule distributor, in accordance with the invention, employ the concept of multi-instancing.

An embodiment of the invention depicts a single running process of RTFM that maintains multiple instances of the relevant data structures for each instance. The instance identifier is embedded in all interfaces exported by RTFM to other modules and to the relevant data structures. The invention also illustrates the intelligent scheduling required within RTFM to process multiple instances.

An RTFM instance may be created upon a number of events or triggers, such as: (a) configuration/provisioning of an instance on a given node by a user, e.g. a virtual router; (b) creation of the first physical/logical interface on a given node for the particular instance; (c) registration of the first application protocol for a given instance; and (d) trigger for the creation and distribution of the instance-rules to a given card could be the first packet arriving on the card for that instance.

Embodiments of the invention also propose the extension of the BSD socket interface to support IP multi-instancing based applications. Also provided, preferably, is a scheme in the socket layer to support multi-instancing within a single running process under the socket layer. Examples of multi-instance applications are virtual private network, virtual routing and forwarding table, or multiple virtual private networks within a virtual routing and forwarding table, and the mechanism of implementing multi-instancing in the socket layer as part of a single running process.

### BRIEF DESCRIPTION OF THE FIGURES

The invention is now described by way of reference to particular embodiments with regard to the accompanying drawings, in which:

FIG. 1 illustrates an exemplary distributed routing platform for implementation of an embodiment of the invention;

FIG. 2 illustrates a functional block diagram of an exemplary implementation of the routing modules shown in FIG. 1;

FIG. 3 illustrates an exemplary architecture of a routing table and flow module of FIG. 2;

FIG. 4 illustrates a flow diagram for an exemplary operation of the routing table and flow module of FIG. 1;

FIG. 5 illustrates multiple instances of routing table and flow modules in accordance with an embodiment of the invention;

FIG. 6 illustrates a routing table and flow module and rule distributor multi-instancing distributed as part of a single process in accordance with an embodiment of the invention;

FIG. 7 illustrates the concepts of a socket layer and socket library in accordance with an embodiment of the invention; and

FIG. 8 depicts multi-instancing of the socket layer in accordance with an embodiment of the invention.

### DESCRIPTION OF THE PREFERRED EMBODIMENTS

The invention is described herein by way of reference to particular exemplary embodiments. The invention is not limited however to any specific aspects of such embodiments. In particular the invention is described in the context of two preferable embodiments.

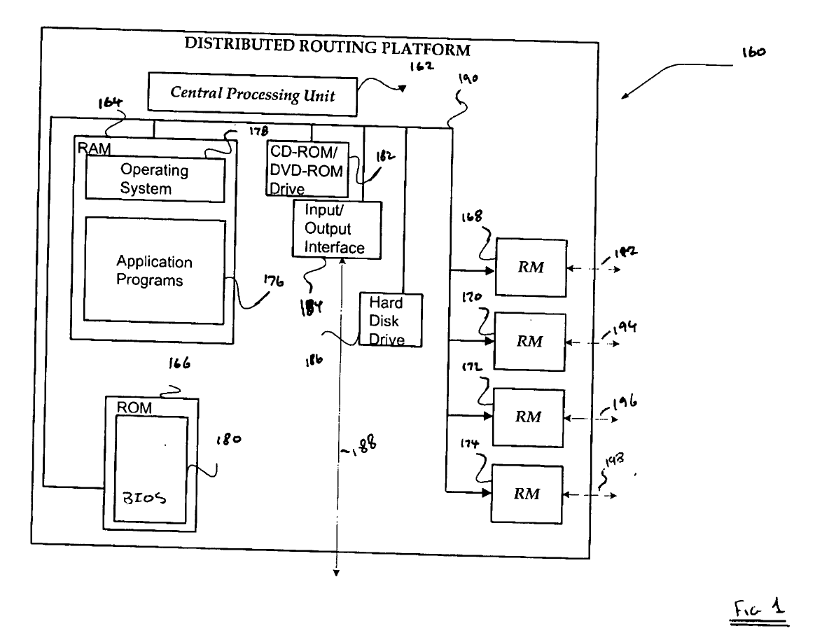

A first preferable embodiment is now presented in the context of a distributed routing platform. FIG. 1 is a block diagram generally illustrating an exemplary distributed routing platform.

The exemplary distributed routing platform, generally denoted by reference numeral 160, includes a central processing unit (CPU) 162, a random access memory (RAM) 164, a read-only memory (ROM) 166, and a plurality of routing modules (RMs) 168, 170, 172, 174.

The RAM 164 may store application programs as denoted by reference numeral 176, and operating system software as denoted by reference numeral 178. The ROM 166 may store basic input/output system (“BIOS”) programs, as denoted by reference numeral 180.

The distributed routing platform 160 may also comprise an input/output interface 184 for communicating with external devices, via a communication link 188, such as a mouse, keyboard, or display. The distributed routing platform 160 may also include further storage mediums, such as a hard disk drive 186 or connectable storage mediums such as a CD-ROM or DVD-ROM drive 182.

The various elements of the distributed routing platform 160 are connected internally via a common bus denoted by reference numeral 190.

The distributed routing platform 160 shown in FIG. 1 illustrates four routing modules 168 to 174. Each of the four routing modules 168 to 174 is provided with a respective interface 192 to 198, for communicating external to the platform. The number of routing modules shown in FIG. 1 is illustrative, and in practical implementations a distributed routing platform may have less than four routing modules, or many more than four routing modules.

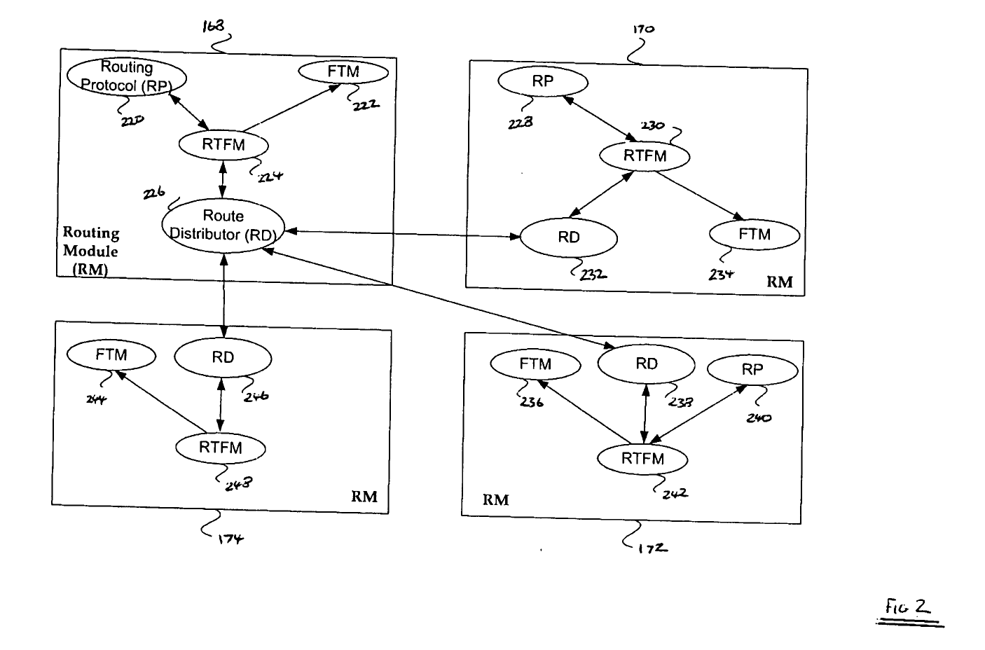

In order to further understand the first described embodiment, reference is further made to FIG. 2 which illustrates a functional block diagram of an exemplary implementation of the four routing modules shown in FIG. 1. Like reference numerals are used to denote elements corresponding to those shown in FIG. 1.

Routing module 168 includes a routing protocol (RP) block 220, a forwarding table module (FTM) block 222, a route table and flow management (RTFM) block 224, and a route distributor (RD) block 226. The routing module 170 includes an RP block 228, an FTM block 234, a RTFM block 230, and an RD block 232. The routing module 172 includes an RP block 240, an FTM block 236, an RTFM block 242, and an RD block 238. The routing module 174 includes an FTM block 244, an RTFM block 248, and an RD block 246.

The distribution of RTFMs and RDs across multiple routing modules, as shown in FIG. 2, is known in the art of distributed routing platforms, and is intended to minimise congestion of routing updates to the various routing protocol blocks throughout the distributed routing platform.

Within each of the routing modules 168, 170, 172, the RTFM block is in connection with each of the FTM, RD, and RP blocks. In routing module 174 the RTFM block is in communication with the FTM and RD blocks.

The routing protocol (RP) blocks 220, 228, 240 are configured to determine a routing protocol that enables a packet to be forwarded beyond a local segment of a network toward a destination. The routing modules may employ a variety of routing protocols to determine routes, as known in the art.

The forwarding table modules (FTMs) 222, 234, 236, 244 are configured to map a route, route information, IP flow information, or similar to a forwarding table consulted for forwarding packets at the routing module.

The routing table and flow management blocks 224, 230, 242, 248 determine a best route. Preferably at least one RTFM of the routing modules is designated as a master RTFM, and the other RTFMs within the distributed routing platform are then designated as slave RTFMs. The RTFMs are also configured to manage routing rules that enable routing of a packet. Such routing rules may specify services that are performed on certain classes of packets by the RTFMs, and the ports to which the packets are forwarded. The RTFMs are adapted to enable distribution of packets, routing rules, routes, and similar to the routing protocol blocks and the routing distributor blocks.

The master RTFM preferably includes a database that is configured to store a global best route and associated route information, and a master-forwarding rule for the distributed routing platform. The master RTFM may also manage identifiers associated with each routing protocol within the distributed routing platform.

The routing distributor blocks 226, 232, 238, 246 are configured to enable an exchange of route and route information between the routing modules within the distributed routing platform. The route distributor blocks facilitate a uniform presentation of the routing rules, routes, and route information independent of the routing module within which the information originates. This facilitates a scaleable distributed routing architecture. The route distributor blocks 226, 232, 238, 246 are preferably arranged so as to isolate the RTFM blocks within the respective routing modules, such that the RTFM blocks do not directly communicate with other routing modules and therefore do not know with which nodes the various routing protocols reside. As such, route and routing information associated with the routing protocol block may be made readily accessible to each RTFM across the distributed routing platform. Generally, at least one route distributor block is designated as a master RD, with the other RD blocks being designated as slave RDs. The slave RDs are preferably configured to communicate through the master RD. The master RD is able to manage global decisions across the distributed routing platform. For example, the master RD may determine which route, routing rule, packet flow etc. is a global best among conflicting information received from slave RDs.

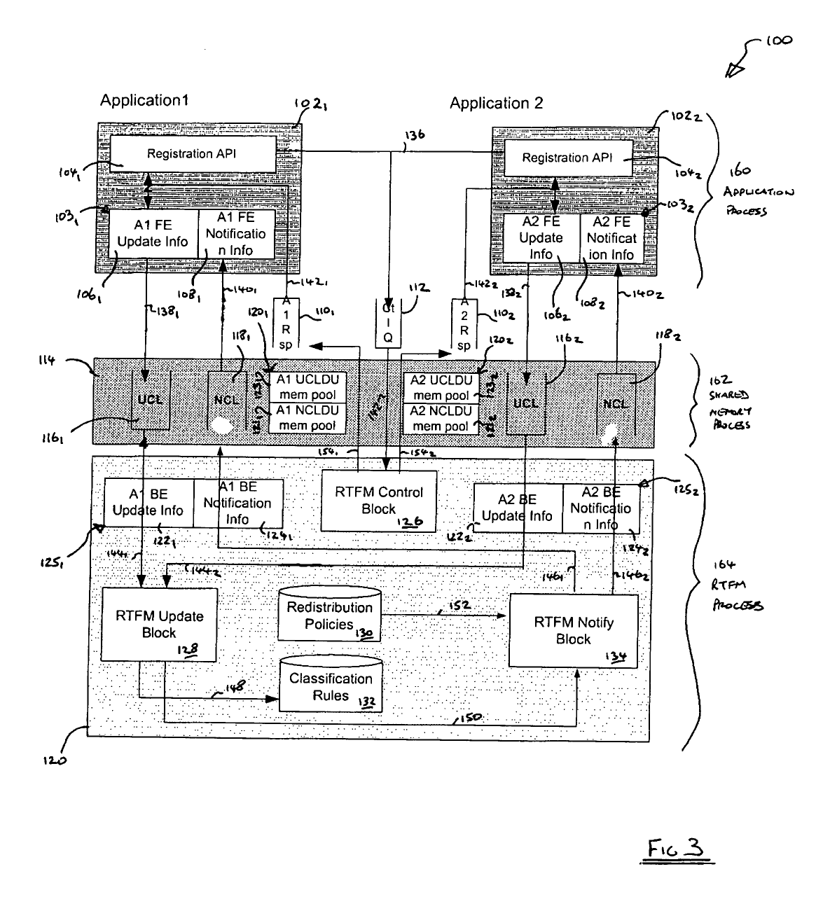

In order to further understand the invention as it applies to the first embodiment, reference is now made to FIG. 3 with which there is described an exemplary architecture of a routing table and flow module (RTFM) as shown in each of the routing modules of FIG. 2. As denoted in FIG. 3, the RTFM architecture may generally be separated into an application process 160, a shared memory 162, and an RTFM process 164. The shared memory is shared memory for the routing module, and not shared between routing modules.

The application process 160 may contain a plurality of processes. In the embodiment illustrated in FIG. 3, two application processes are provided. A first application process is represented by block 102₁, and a second application process is denoted by block 102₂. Each of the application process blocks 102₁ and 102₂ contain a registration API block 104, and an RTFM front-end (FE) 103.

The shared memory process 162 comprises an update change list (UCL) buffer 116 for each of the applications, respectively denoted 116₁ and 116₂, and a notified change list (NCL) buffer 118 for each of the applications. In addition, associated with each of the applications is a respective memory pool 120, and 120₂.

The RTFM process block 164 comprises an RTFM back-end 125 for each of the applications, being a respective back end 125₁ and 125₂. In addition the RTFM process 164 includes an RTFM control block 126, an RTFM update block 128, an RTFM notify block 134, a classification rules block 132, and a redistribution policies block 130.

The RTFM update block 128 is the functional block within the RTFM process 164 that handles the rule database, operations on the rule database, the best rule decision making, etc. The RTFM notify block 134 handles the redistribution or leaking of rules from the rule database to the applications that are registered for notification.

The classification rules block 132 is the rule database. The rule database itself consists of all the rules added by the applications. These are maintained in an efficient manner. Examples of ways in which the rules may be maintained are, for example, patricia/binary trees for routes, hash tables for flows, etc. The maintenance of such a rule database is known in the art, and known maintenance techniques may be applied.

The redistribution policies block 130 includes a redistribution template. The redistribution template consists of the rules that have been configured to enable redistribution or leaking of rules from one application to another within the same routing domain.

As illustrated in FIG. 3, the RTFM functionality is split into two parts, a back-end part and a front-end part, between the RTFM process 164 and the application process 160. The back-end part, provided by the back-end blocks 125, is the core RTFM that accepts and maintains the rule and redistribution databases, makes best rule decisions, performs redistribution, etc. The front-end part, in front-end blocks 103 associated with the respective application processes is the RTFM API library. For fast and efficient access, some of the RTFM data structures are cached or shared so that the front end can access these without operating system context-switch overhead.

A change list is a mechanism and data structure to enqueue rule operations from a routing protocol or RTFM application to RTFM, in an efficient manner that does not involve a context-switch, and the operations optimised in such a way that the memory required is bound by the maximum number of rules despite continuous flapping operations. There are two types of change lists, update change lists (UCL) and notification change lists (NCL). UCL are used for rule insertion to RTFM, whereas NCL are used for rule notification from RTFM.

The RTFM also has an application-type component. The application-type component itself has two components, the application owner and the owner instance. The owner field carries the owner identifier, for example open shortest path first (OSPF), border gateway protocol (BGP). Owner instance represents the logical instancing within the application in the same routed domain.

The application type is an identifier for the application, and would be maintained as part of the instance control block, as well as maintained as part of each rule in the routing database.

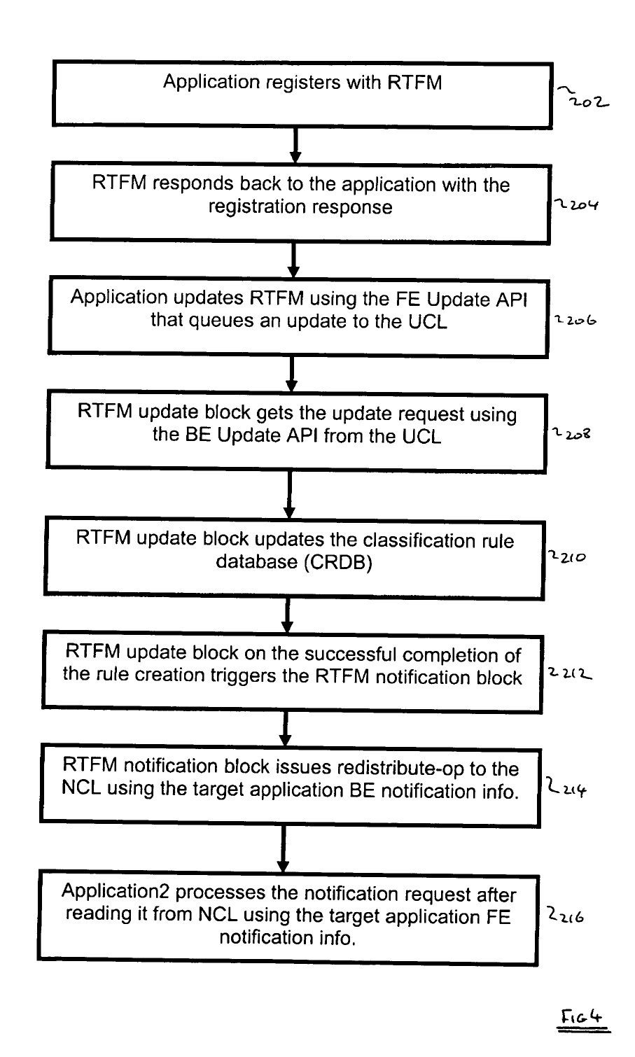

With reference to FIG. 4, an example operation of the RTFM of FIG. 3 is now further illustrated.

In a first step 202, an application registers with the routing table and flow module. For example, the first application represented by the application process block 102₁ may register with the RTFM. As such, an appropriate registration message is transmitted from the registration API block 104₁ on line 136 toward the shared memory process block 162. This registration message is received in a control queue block (“Ctl Q”) 112. This block is a means for inter-process communication, and acts as a buffer for registration requests made toward the RTFM process 164. The buffer 112 then forwards the registration requests on a line 142 to the RTFM control block 126 of the RTFM process block 164.

In a step 204, the RTFM process block 164 responds back to the application 102, with a registration response. The registration response is sent on a line 154₁ towards the application 102₁. The registration response is received in a response buffer (“Rsp”) 110₁, being an input buffer for the first application process block 102₁. The registration response is then forwarded to the registration API block 104, of the first application, and the front end 103₁ of the first application.

The front-end of the first application block comprises two parts, a front-end update information block 106₁, and a front-end notification information block 108₁. Similarly other application blocks, such as the second application block 102₂, have similar update and notification information blocks 106 and 108.

The update information block 106₁ of the front-end of the first application receives the registration response from the RTFM.

In a step 206, and responsive to a positive registration response, the application then updates the RTFM using the front-end update information block 106₁. An update is sent on line 138, from such block, to the UCL buffer 116₁. The UCL buffer 116₁ queues updates from the first application, hence its designation as an ‘update change list’.

The back-end blocks 125 are split into two parts, in a similar way to the front-end blocks 103. Each back-end block 125 includes a back-end update information block 122 and a back-end notification information block 124. Thus, for the first application, the back-end block 125₁ includes an update information block 122₁ and a notification information block 124₁.

The back-end update information block 122₁ for the first application receives updates from the UCL 116₁ and forwards such to the RTFM update block 128. Thus, in a step 208, the RTFM update block 128 receives the update request from the first application using the back-end update information block 122₁ which retrieves, or schedules, updates from the UCL 116₁.

In a step 210, the RTFM update block 128 then updates the classification rule database (CRDB) by sending an appropriate message on line 148 to the classification rules block 132.

On successful completion of the rule, i.e. on successful update of the classification rule database, a trigger is transmitted on line 150 from the RTFM update block 128 to the RTFM notify block 134. This is represented by step 212.

Responsive to the trigger from the RTFM update block 128, the RTFM notify block 134 issues a “redistributes-op” message toward the notify change list associated with the applications other than the first application, i.e. the applications not responsible for the change. As denoted by step 214, this is achieved in the described example by transmitting the message on line 146₂ to the notification information block 124₂ of the second application, which in turn forwards such notification to the NCL buffer 118₂. The NCL buffer 118₂ feeds notifications to the front-end notification information block 103₂ of the second application process block 102₂.

As denoted by step 216, the second application then processes the notification request after receiving it from the NCL buffer 118₂ using the front-end notification information block 103₂.

It should be noted that in the event that more than two applications are provided, each of the other applications are provided with a notification. Thus, responsive to a change (or update) from any one application, all other applications receive a notification of this change.

The first embodiment of the invention described herein is particularly related to a distributed routing platform in which multiple instances are supported by one or more routing modules. Each instance holds the routing/flow information for a given routing domain. For example, a router may route packet flows for multiple domains, in which case the router may be considered to process multiple instances. Examples of domains are virtual private networks (VPNs).

A single RTFM may thus process multiple active instances. For example, a single RTFM may process route addition/deletion messages, etc. for multiple instances. The number of instances handled by an RTFM may be high, and therefore an efficient mechanism is required to process all the instances in the RTFM in a fair and efficient manner. This may be facilitated by front-end blocks of a routing module's RTFM (discussed further hereinbelow) marking the active instances to which new rules are added in a shared table. When scheduled, the RTFM may scan this table to identify the instances that have some activity, and process them. Weights are added to the table to ensure a weighted allocation of CPU time for each instance. The weights may also be adjusted to prioritise critical instances. The RTFM may also provide a special application interface to ‘walk’ the instances that have pending entries in their change list.

The RTFM may support at least the following application interface specifics for multi instancing:
1. To register/unregister from a specific RTFM instance;
2. To add/delete/modify rules for a specific instance;
3. To search/walk the rules in the rule database for a specific instance; and
4. To check the notification change list of a specific instance.

An RTFM instance is passed as one of the parameters to the above application interfaces. The application interface and data structures are multi-thread and symmetrical multi-processing (SMP) safe. This is achieved through the use of read-write locks for data structures. The locks are granular to the level of instances, so the processing of one instance in one thread does not affect the processing of another instance in another thread.

RTFMs may be implemented in a distributed routing platform system as discussed above. A distributed routing platform may typically operate on a server, workstation, network appliance, router, bridge, firewall, gateway, traffic management device, or such like. A distributed platform may typically include a processing unit and memory, as well as routing modules (RM). The routing modules contain the routing tables that direct the routing of packets received by the platform. The routing modules may be configured to perform services, or to forward packets to other routing modules to perform services. The routing modules also provide routes, or routing protocol information, to each other, thereby enabling multiple routing protocols to be executed on different routing modules. Each routing module may represent a separate node.

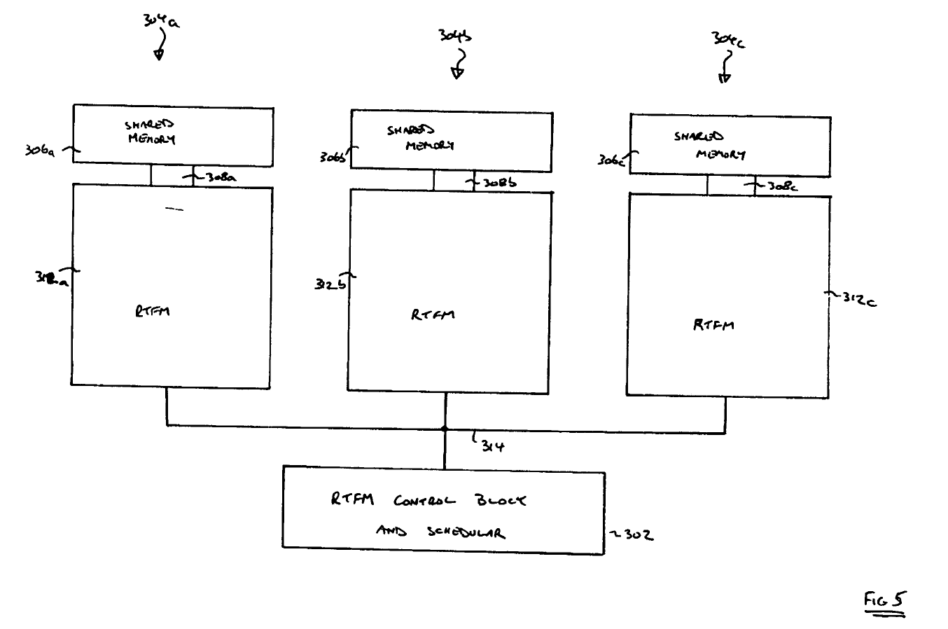

With reference to FIG. 5, there is generally illustrated a distributed system in which there is provided three routing modules (RMs), generally illustrated by reference numerals 304a, 304b, 304c. Each routing module generally includes a main RTFM functional block 312, a shared memory 306, and an interface 308 between the shared memory and the functional block 310. Each of the RTFMs 312 is provided with a connection on an interface 314 to an RTFM control block and scheduler 302, which controls all of the distributed RTFMs.

In order to provide a scalable routing infrastructure, it is not necessary to replicate all routing domains, or more generally all instances, in every node in the system. The routing instances may be distributed across the nodes through internal policies (for example based on load sharing). The RTFM instances on the different nodes may also be maintained in the same way. Various data structures required for an instance are maintained only on the nodes that are part of any given instance.

The RTFM also supports RTFM sub-instancing, to handle applications that need logical instancing within a given routing domain. This, for example, may be multiple OSPF (open shortest path first) routing processes within the same virtual router (VR). For this the application provides the logical instance along with the application information. Though the rule database remains the same, the RTFM has the intelligence to use this information in redistribution policies.

As described above each routing module also includes a rule distributor, which is not shown in FIG. 5. The rule distributor (RD) module is aware of the RTFM instances in the RM. The RD module is a client of the RTFM, and communicates to the RTFM through the change list-based application interface. The RD thus communicates with the RTFM through the back-end update/notification information blocks as discussed hereinabove with reference to FIG. 1. The RD module distributes rules to all nodes in the distributed system. Preferably, rules are maintained only on the nodes that are part of a given routing instance. This is achieved by either sending only relevant rules from the sending node to all the nodes, or by filtering the rules at the receiving node.

When a new node is ‘plugged-in’, all the rules for the instances configured on that node are updated in bulk to the new node, so that it is in synchronisation with the master node. Similarly, if a node is newly associated with an instance, all the rules for the instance configured or learnt on the other nodes are also updated to the new node.

Hot-standby redundancy is supported for the master as well as the slave nodes. The detailed discussion of such redundancy is beyond the scope of the invention, and is known in the prior art.

On an SMP system, RTFM may be made multi-threaded for load sharing with each thread handling a set of RTFM instances, or by distributing key functionalities for all instances to multiple threads.

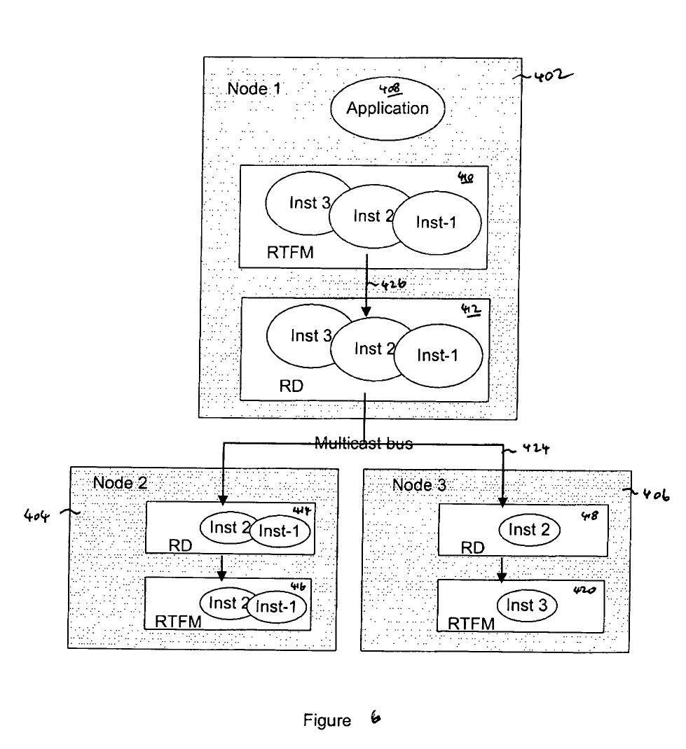

Referring to FIG. 6, there is illustrated an example in which there is provided three distributed nodes 402, 404 and 406. The first node 402 associated with the application 408 is considered to be the master node in respect of such example, and the second and third nodes 404 and 406 are considered to be slave nodes. The node 402 has an RTFM 410 which is associated with three instances, “Inst 1”, “Inst 2” and “Inst 3”. The RTFM 410 communicates with a rule distributor 412 for the node 402, which similarly has three associated instances. The rule distributor 412 is connected to a multicast bus 424. The multicast bus 424 is further connected to rule distributors for all slave nodes. Thus a rule distributor 414 of node 404 and a rule distributor 418 of node 406 are connected to the multicast bus 424. The node 404 is associated with the first and second instances, and the node 406 is associated with the third instance. The RTFM of each of the respective slave nodes 404 and 406 is notified of rule updates by transmissions from the rule distributor 412 on the multicast bus 424, and received at their own respective rule distributors.

In principle, the routing tables of multiple instances are mutually exclusive, and there is no relation across instances. However for special cases the following inter-instance interaction may be supported:
1. Broadcast/multicast, namely the ability to add a given route to “n” instances; and
2. The ability to leak/redistribute routes across “n” instances.

The different RTFM instances are completely independent. Hence it may be used for purposes other than basic operations like a virtual router (VR) or a virtual private network (VPN). This can be illustrated by examples.

In a distributed routing infrastructure, for example, packets may arrive in one card and depart from another card. There may be rules applicable only in one direction of traffic. The separation of the ingress rules and the egress rules may be done by creating an ingress instance and an egress instance of RTFM.

In a typical routing table implementation, by way of further example, only the best rules may be exposed to applications. However in the case of tunnelled interfaces, a destination may be reachable both through the tunnelled path, or through direct interface itself, and both paths may need to be accessible to the application. By maintaining them as individual instances, this can be achieved.

It should be noted that reference is made herein, by way of example, to routes and to routing tables. In general, these references should be understood as specific examples of rules and classification rule tables. A route is one example of a classification rule. The processing of classification rules involves processing that may not be achieved by the regular routing processes/protocols.

In a technique in accordance with embodiments of the present invention, being a generic multi-instancing scheme, a packet may be looked-up against a series of different instances in a look-up table. Such an instance chaining policy may be predefined, or formed dynamically. Each instance look-up may provide the next instance to be looked up. The incoming packet header contents, such as the L2 to L7 headers, may also be used to derive the look-up policy.

A second preferable embodiment is now described. The second embodiment proposes extensions in the BSD socket interface to implement socket multi-instancing to support multi-instanced applications.

A multi-instancing model involves the implementation of multiple logical instances like the virtual router instances described above, as part of a single process having multiple instances of the data structures. There is no known standard extension to the BSD socket interface to support multiple instances that is transparent and backward compatible. There is no known generic distributed multi-instancing model for sockets and TCP/IP that is known to be available. This second preferred embodiment presents such a model.

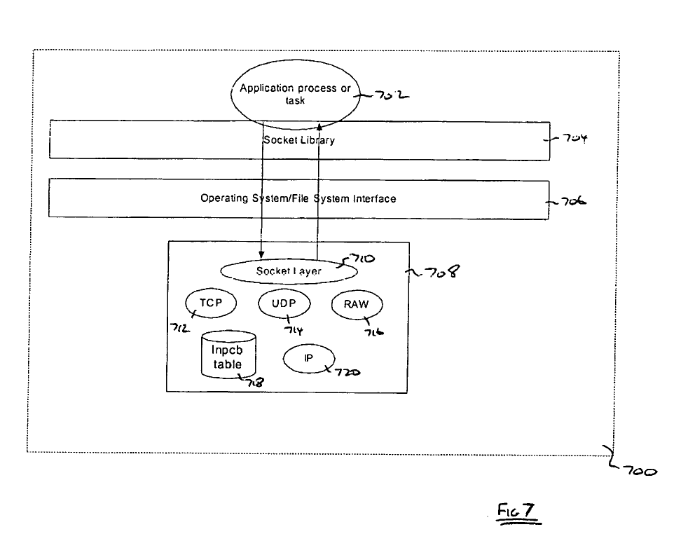

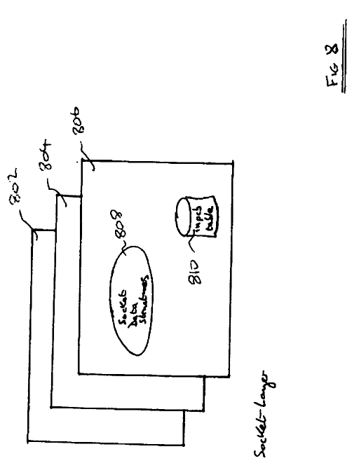

Referring to FIG. 7, there is illustrated, by way of further example, the concepts of the socket layer and the socket library. FIG. 8, described further herein below, depicts the multi-instancing of the socket layer.

In FIG. 7 there is generally shown, as represented by reference numeral 700, a socket library 704, an operating system/file system interface 706, an application process or task 702, and a socket 708. The socket includes a socket layer block 710, a TCP stack or block 712, a UDP stack or block 714, a RAW stack or block 716, an IP stack or block 720, and an lnpcb table block 718.

The application process or task 702 interfaces with the socket layer block 710.

In FIG. 8, there is shown three sockets 802, 804, 806. Each socket, such as socket 806, includes a block of socket data structures 808, and an Inpcb table block 810.

During the creation of a new instance, through the configuration of or the creation of a first socket, the socket layer 710 and the TCP/IP stack 712/720 create multiple instances of the relevant data structures, such as the data <Source address, Destination Address, Source port, Destination port, protocol>, in the lookup table.

In a distributed system, if this operation needs services from other nodes, and the information is conveyed to the socket layers in those other nodes as well.

In a redundant system, the information is conveyed to a redundant card for the allocation of resources for this operation.

The underlying IP implementation has the capability of sending packets on a given IP instance, and to identify the IP instance for an incoming packet. The instance information is exchanged between the socket layer 710 and the IP module 720 while transmitting and/or receiving packets.

The socket applications can attach a socket to a specific instance. Once attached to a specific instance, all packets received on the given instance only are passed to the application, and the packets sent out on the socket are sent out on the specified instance. A given socket may be attached to only one IP instance.

Listening server sockets (for TCP/stream sockets) may attach to the set of all instances. When a new connection is established, a ‘child’ (or slave) socket that is created is attached to the instance on which the packet came in. This information is sent to the application as part of the ‘accept’ parameters, which parameters are known in the art.

For raw socket applications, the packets coming on an interface are passed for a given protocol, registered by the application, to all the applications that have registered, and it is the responsibility of the application to choose the appropriate packets. This is in line with the normal processing of packets for raw sockets.

The extensions in the data structures in a preferred implementation are now described. The sockaddr_in structure is preferably used to pass information between the socket application and the socket layer regarding the address family, IP address, port, etc. The reserved fields in this structure can be used to indicate the IP instance information. This is illustrated below.

Struct sockaddr

{

| | |
|---|---|
| unsigned char | sa_len; |
| unsigned char | sa_family; |
| char | sa_data[14]; |

};

Existing sockaddr_in:

Struct sockaddr_in
{

| | | |
|---|---|---|
| unsigned char | sin_len; | /* total length */ |
| unsigned char | sin_family; | /* address family */ |
| unsigned short | sin_port; | /* Port */ |
| struct in_addr | sin_addr; | /* IP Address */ |
| unsigned char | sin_zero[8]; | /* Reserved */ |

};

Proposed sockaddr_in:

Struct sockaddr_in
{

| | | |
|---|---|---|
| unsigned char | sin_len; | /* total length */ |
| unsigned char | sin_family; | /* address family */ |
| unsigned short | sin_port; | /* Port */ |
| struct in_addr | sin_addr; | /* IP Address */ |
| unsigned long | sin_instance; | /* IP instance */ |
| unsigned char | sin_zero[4]; | /* Reserved */ |

};

An attachment of a socket to an instance is now described. An application can attach to a specific IP instance using the IP_INSTANCE socket option. The sample code for client socket/server socket for a specific instance is as follows:

int sid;
int ipInstanceId;
if((sid = socket( . . . )) < 0)
{

ERROR

}
/* Get ip instance id for the given routing domain value */
ipInstanceId = get_ip_instance_from_rd(routing domain);
if(setsockopt(sid, IP_PROT_IP, IP_INSTANCE,

(void *)&ipInstanceId sizeof(ipInstanceId)) == ERROR)

{

/* Perform error processing */

}
. . .

Other socket calls like bind, connect, send may be performed after this. A server TCP application may attach to the set of all IP instances in the following manner:

UINT32 anyInstanceId;
Int sid;
/* open a socket and wait for a client */
if((sid = socket (AF_INET, SOCK_STREAM, 0)) < 0)
{

ERROR

}
anyInstanceId = IP_ANY_INSTANCE;
if(setsockopt(sd, IP_PROT_IP, IP_INSTANCE,

(void *)&anyInstanceId sizeof(anyInstanceId)) == ERROR)

{

ERROR

}
. . .

When accept returns as the result of a new connection, it will give the correct instance in the sockaddr structure.

struct sockaddr_in2 sa;
int len;
RD routingDomain;
if ((childsid = accept(sid, &sa, &len)) < 0)
{

ERROR

}
// sa->sin_instance contains the IP instance id.
RoutingDomain = get_rd_id_from_ip_instance(sa->sin_instance)

A query routine is now described. The applications may query the socket module to obtain the instance association using the following routines:
1. getsockopt, with IP_INSTANCE.
2. getpeer routine, for TCP/stream sockets. The instance value is returned in the sin_instance field of the sockaddr_in structure.

Advantages of the proposed extensions to the socket API include the following. The technique enables client/server socket applications to communicate with the underlying IP multi-instancing infrastructure. Transparent changes to the socket API, result in backward compatibility with existing applications. The generic implementation is extensible to any type of multi-instancing application, for example VR, VPN, VRF.

Advantages of multi-instanced socket layer include the following. Teh sockets may be Implemented as a single process against multiple processes in other implementations, hence the operating system requirements are significantly lower, and the implementation is more scalable. A solution is provided for a fully distributed implementation with instances spread across multiple nodes.

There are two key areas of application of embodiments of the invention. A first application is in virtual private networks. This is mainly used by ISPs to provide reliable, secure and cost-effective way of access to corporate domains. Surveys have indicated that most telecommunications and networking organizations are stressing the significance of VPNs. A second application is virtual routers. This is mainly used by, but not restricted to, Mobile Virtual Network Operators (MVNO). In essence it involves the separation of management plane to achieve virtualisation of the GGSN node, such that multiple operators can share a single GGSN and manage resources independently.

The invention has been described in the context of a number of preferred embodiments. The invention is not, however, limited to any specific aspects of such various embodiments. The scope of protection afforded to the invention is defined by the appended claims.

1. A distributed platform, comprising:
a plurality of nodes for controlling a data flow, in which at least one of said plurality of nodes supports multiple instances, wherein there is provided means for distributing classification rules for any given instance between nodes sharing said instance.

2. The distributed platform according to claim 1, further comprising:
a distributed routing platform, said plurality of nodes comprising a plurality of routing modules.

3. The distributed routing platform according to claim 2, wherein at least one of said plurality of routing modules supports multiple instances, wherein there is provided means for sharing classification rules for at least one given instance between routing modules supporting said at least one given instance.

4. The distributed routing platform according to claim 2, wherein an instance comprises a domain.

5. The distributed routing platform according to claim 2, wherein an instance comprises a flow direction.

6. The distributed routing platform according to claim 5, wherein the flow direction comprises at least one of an ingress direction and an egress direction.

7. The distributed routing platform according to claim 2, wherein said plurality of the routing modules support multiple instances, one of said plurality of routing modules being designated as a master routing module for at least one given instance, and controlling a share of classification rules for the at least one given instance.

8. The distributed routing platform according to claim 2, wherein a routing module includes a routing table and flow module configured to store classification rules of the module, and a route distributor configured to distribute the classification rules.

9. The distributed routing platform according to claim 8, wherein the routing table and flow module stores classification rules for those instances associated with its routing module.

10. The distributed routing platform according to claim 9, wherein the route distributor is adapted to distribute classification rules for at least one given instance to rule distributors of other routing modules associated with the instance with which the rule is associated.

11. The distributed routing platform according to claim 2, wherein an instance is created responsive to at least one of an event and a trigger.

12. The distributed routing platform according to claim 11, wherein an instance is created responsive to configuration of an instance at a routing module.

13. The distributed routing platform according to claim 11, wherein an instance is created responsive to creation of at least one of a physical interface and a logical interface at a routing module.

14. The distributed routing platform according to claim 11, wherein an instance is created responsive to registration of an application protocol.

15. The distributed routing platform according to claim 11, wherein an instance is created responsive to receipt of a packet associated with an instance.

16. The distributed platform according to claim 1, further comprising:
a distributed socket platform, said plurality of nodes comprising a plurality of sockets.

17. A distributed routing platform wherein at least one socket is adapted at the API layer to support multi-instancing.

18. The distributed platform according to claim 8, wherein said plurality of sockets comprise Berkeley domain sockets.

19. A Berkeley domain socket comprising:
an application interface layer adapted to support multi-instancing.

20. A method for a distributed platform including a plurality of nodes for controlling a data flow, the method comprising:
adapting at least one of said plurality of nodes to support multiple instances; and
distributing classification rules for any given instance between nodes sharing said instance.

21. The method according to claim 20, wherein the distributed platform comprises a distributed routing platform, said plurality of nodes comprising a plurality of routing modules.

22. The method according to claim 21, wherein at least one of said plurality of routing modules supports multiple instances, the method further comprising the step of:
sharing classification rules for at least one given instance between routing modules supporting said instance.

23. The method according to claim 21, wherein an instance comprises at least one of a domain and a flow direction.

24. The method according to claim 23, wherein the flow direction comprises at least one of an ingress direction and an egress direction.

25. The method according to claim 21, wherein a plurality of the routing modules support multiple instances, the method further comprising the step of:
designating one of said plurality of routing modules as a master routing module for at least one given instance; and
controlling a share of classification rules for that instance.

26. The method according to claim 21, wherein a routing module includes a routing table and flow module configured to perform the step of storing classification rules of the module, and a route distributor configured to perform the step of distributing classification rules.

27. The method according to claim 26, further comprising the step of:
storing the classification rules in the routing table and flow module stores only for those instances associated with its routing module.

28. The method according to claim 27, wherein the route distributor performs the step of distributing classification rules for at least one given instance to rule distributors of other routing modules associated with the instance with which the rule is associated.

29. The method according to claim 21, further comprising the step of:
creating an instance responsive to an event or trigger.

30. The method according to claim 29, further comprising the step of:
creating an instance responsive to configuration of an instance at a routing module.

31. The method according to claim 29, further comprising the step of:
creating an instance responsive to creation of at least one of a physical interface and a logical interface at a routing module.

32. The method according to claim 29, further comprising the step of:
creating an instance responsive to registration of an application protocol.

33. The method according to claim 29, further comprising the step of:
creating an instance responsive to receipt of a packet associated with an instance.

34. The method according to claim 20, further comprising a distributed socket platform, said plurality of nodes comprising a plurality of sockets.

35. The method according to claim 34, further comprising the step of:
adapting each socket at the API layer to support multi-instancing.

36. The method according to claim 34 wherein said plurality of sockets comprise Berkeley domain sockets.

37. A distributed routing platform including a plurality of routing modules for controlling a data flow, in which a plurality of said nodes support multiple instances, wherein each routing module includes a routing table and flow module for storing classification rules associated with the instances supported by a respective routing module, and a route distributor for distributing there is classification rules for any given instance between routing modules sharing said instance.

38. A distributed routing platform according to claim 37 wherein the route distributor of each routing module is adapted to communicate with route distributor of each other routing module, such that the routing table and flow module of each routing module receives classification rules associated with its supported instances.

39. A distributed platform, comprising:
a plurality of means for controlling a data flow, in which at least one of said plurality of means supports multiple instances, wherein there is further provided means for distributing classification rules for any given instance between nodes sharing said instance.

40. A Berkeley domain socket comprising:
means adapted to support multi-instancing.

41. A distributed routing platform including a plurality of means for controlling a data flow, in which a plurality of said means support multiple instances, wherein each means includes a routing table means and a flow module means for storing classification rules associated with the instances supported by a respective means for controlling a data flow, and a route distributor means for distributing classification rules for any given instance between means for controlling a data flow sharing said instance.

42. A computer program product adapted to store computer program code for performing a method comprising: adapting at least one of a plurality of nodes for controlling a data flow for a distributed platform to support multiple instances; and distributing classification rules for any given instance between nodes sharing said instance.
